(19) United States
(12) Patent Application Publication
(10) Pub. No.: US 2011/0010991 A1
(43) Pub. Date: Jan. 20, 2011

(54) CONTAINER FOR CULTURE OF PLANT, METHOD FOR CULTURE OF PLANT AND METHOD OF PRODUCTION OF CUTTING SEEDLING

(76) Inventors: Yuji Fujii, Tokyo (JP); Akiyoshi Kawaoka, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/922,508

(22) PCT Filed: Feb. 20, 2009
(86) PCT No.: PCT/JP2009/000725

§ 371 Date: Sep. 16, 2010

(30) Foreign Application Priority Data
Mar. 18, 2008 (JP) 2008-069058

(51) Int. Cl. A01G 9/02; A01G 1/00

(52) U.S. Cl. 47/66.7; 47/85

(57) ABSTRACT

Provided are a plant cultivation container, a plant cultivation method, and a method of producing a rooted cutting, in which a plant can be cultivated under a desired humidity condition, whereby a rooting rate can be enhanced and extension of a root can be promoted. In the plant cultivation container in which a plant cultivating medium (2) is provided in an inside of a container body (1) with a substantially hermetically sealed structure, a partition wall (3) that partitions the inside of the container body (1) into two upper portion and lower portion and supports the medium (2) is provided in the container body (1). The upper portion of the container body (1) defined by partitioning of the partition wall (3) constitutes a high-humidity chamber (4), and the lower portion of the container body (1) constitutes a low-humidity chamber (5). A bent hole (7) that allows the medium (2) and the low-humidity chamber (4) to communicate with each other is provided in the partition wall (3). A high-humidity state is achieved in the high-humidity chamber (4), and a low-humidity state is achieved in the low-humidity chamber (5). Low-humidity air is supplied from the vent hole (7) to the medium (2).

### TECHNICAL FIELD

The present invention relates to a plant cultivation container in which a plant cultivating medium is provided in an inside of a container body, to a plant cultivation method, and to a method of producing a rooted cutting which use the plant cultivation container.

### BACKGROUND ART

Conventionally, there has been known plant cultivation using a plant cultivation container in which a plant cultivating medium is provided in an inside of a container body. As the plant cultivation using the plant cultivation container, for example, there is production of a rooted cutting. Such cuttage is a cultivation method of inserting a cut region of an artificially cut plant tissue (cutting) into the medium, and rooting the cut region in the medium, thereby creating one independent plant body. The cuttage is widespread as a cultivation method of producing/multiplying a large quantity of clone saplings provided with the same gene properties as those of a parent plant. Here, the cuttage is applied to a wide range of plants from the herbage to the arboreous plant.

In the production of the rooted cutting, an environment around the rooted cutting must be maintained at a relatively high humidity during a period until the cutting is rooted and a healthy sapling is formed. This is because, when the humidity is low, the cutting withers and weakens owing to a transpiration function from leaves thereof, and the like. As a result, a good-quality rooted cutting cannot be obtained, and in addition, productivity of the rooted cutting is decreased. In terms of this point, the method of producing a rooted cutting, which uses the plant cultivation container, is advantageous since it is easy to thereby maintain the inside of the container at the high humidity (for example, refer to Patent Document 1).

Further, not only in the case of the plant cultivation by the cuttage but also in the case of such cultivation that plants a seed and a sapling into the medium, it is considered that an environment around the seed and the sapling should be maintained at the relatively high humidity. Therefore, in the cultivation of the plant, during the period until the healthy sapling is formed, the entirety of the sapling has been maintained in a high-humidity state.
Patent Document 1: Japanese Patent No. 3861542

### DISCLOSURE OF THE INVENTION

### Problems to be Solved by the Invention

As described above, in the case of cultivating the cutting, the seed, and the entirety of the planted sapling while maintaining the cutting, the seed, and the sapling in the high-humidity state, the inside of the medium becomes prone to be excessively humid, and accordingly, such rooting has been adversely affected on the contrary, resulting in an occurrence of problems such as root rot.

It is an object of the present invention to provide a plant cultivation container, a plant cultivation method, and a method of producing a rooted cutting, in which a plant can be cultivated under a desired humidity condition, whereby a rooting rate can be enhanced and extension of a root can be promoted.

### Means for Solving the Problem

As a result of conducting test and research over and over again for the purpose of cultivating the sapling under the desired humidity condition, the inventors of the prevent invention found the following fact. Specifically, even in the case of such cultivation that plants the cutting and the seed, which are not rooted yet, and the sapling immediately after the transplantation, if an environment around portions thereof on the ground, that is, an environment around the portions of these cutting, seed, and sampling, which are exposed on the medium, is maintained at a high humidity, then formation of roots is not adversely affected even if an environment around portions thereof under the ground, that is, an environment around the portions thereof in the inside of the medium is set to a low humidity. In addition, if the sapling is formed while maintaining the environment around the sapling on the ground at the high humidity and the environment around the sapling under the ground at the low humidity, the rooting rate is rather enhanced, and the extension of the root is also improved. Thus, the inventors of the present invention have completed the present invention.

In order to solve the above-mentioned problems, an invention as described in claim 1 is a plant cultivation method that is performed by using a plant cultivation container in which a plant cultivating medium is provided in an inside of a container body with a substantially hermetically sealed structure, the plant cultivation method including: setting an upper portion of the container body in a high-humidity state and setting a lower portion of the container body in a low-humidity state, the container body being provided with a partition wall for partitioning the inside thereof into these two upper portion and lower portion, and for supporting the plant cultivating medium; and supplying low-humidity air to the plant cultivating medium from a vent hole provided in the partition wall, the vent hole allowing the plant cultivating medium and the lower portion set in the low-humidity state to communicate with each other.

An invention as described in claim 2 is a plant cultivation container in which a plant cultivating medium is provided in an inside of a container body with a substantially hermetically sealed structure, the plant cultivation container including: a partition wall that is provided in the inside of the container body, partitions the inside of the container body into two upper portion and lower portion, and supports the plant cultivating medium, the upper portion of the container body partitioned by the partition wall constituting a high-humidity chamber, the lower portion of the container body constituting a low-humidity chamber; and a vent hole portion that is provided in the partition wall and allows the plant cultivating medium and the low-humidity chamber to communicate with each other.

According to an invention as described in claim 3, in the plant cultivation container as described in claim 2, the high-humidity chamber of the container body includes a water reservoir portion for creating high humidity and supplying water to the plant cultivating medium, the container body including a water feed portion that feeds water to the water reservoir portion, an air feed portion that feeds low-humidity air into the low-humidity chamber, and an exhaust portion that exhausts air from the high-humidity chamber.

According to an invention as described in claim 4, in the plant cultivation container as described in claim 2 or 3, the plant cultivating medium is housed in a pot; the vent hole portion provided in the partition wall also serves as a fitting hole that fits to the pot; the pot is supported to be fitted to the fitting hole in a fluid tight manner; the water reservoir portion for creating the high humidity and supplying the water to the plant cultivating medium is provided in the high-humidity chamber of the container body; the water reservoir portion is provided on the partition wall so as to surround a circumferential wall of the pot; the circumferential wall of the pot is provided with a water supply port that supplies the water in the water reservoir portion to the plant cultivating medium housed in the pot; and one of a bottom surface or a circumferential wall of the pot is provided with an air supply port that supplies the air in the low-humidity chamber to the plant cultivating medium housed in the pot, the one of the bottom surface and the circumferential wall protruding from the fitting hole into the low-humidity chamber.

According an invention as described in claim 5, in the plant cultivation container as described in claim 2 or 3, the plant cultivating medium is housed in a pot; the pot is supported on the partition wall so that a bottom surface of the pot abuts on a periphery of the vent hole portion provided in the partition wall in a fluid tight manner; the water reservoir portion for creating the high humidity and supplying the water to the plant cultivating medium is provided in the high-humidity chamber of the container body; the water reservoir portion is provided so as to surround a circumferential wall of the pot; the circumferential wall of the pot is provided with a water supply port that supplies the water in the water reservoir portion to the plant cultivating medium housed in the pot; and the bottom surface of the pot is provided with an air supply port that communicates with the vent hole portion provided in the partition wall and supplies the air in the low-humidity chamber to the plant cultivating medium housed in the pot.

An invention as described in claim 6 is a method of producing a rooted cutting, which is performed by using the plant cultivation container as described in any one of claims 2 to 6, the method including: inserting a cutting into the plant cultivating medium provided in the inside of the container body to cultivate the cutting; and rooting the cutting.

According to an invention as described in claim 7, in the method of producing a rooted cutting as described in claim 6, under conditions in which nitrogen, phosphorus, and potassium are contained in the water in the water reservoir portion while a carbon source is excluded therefrom, the cutting is cultivated while setting humidity in the high-humidity chamber to 90% or more and humidity in the low-humidity chamber to 80% or less and controlling a concentration of carbonic acid gas in the container body so that the cutting is allowed to be rooted.

According to an invention as described in claim 8, in the method of producing a rooted cutting as described in claim 7, the cutting is cultivated under a nonsterile condition.

According to an invention as described in claim 9, there is provided a method of producing a rooted cutting as described in claim 7 or 8, in which the method is performed while controlling the concentration of the carbonic acid gas in the container body to 300 to 1500 ppm.

### Effects of the Invention

According to the plant cultivation method as described in claim 1, the partition wall that partitions the inside of the container body into two upper and lower layers and supports the medium is provided, the upper portion of the container body partitioned by the partition wall is set in the high humidity state, the lower portion of the container body is set in the low-humidity state, the vent hole portion that allows the medium and the lower portion in the low-humidity state to communicate with each other is provided in the partition wall, and the low-humidity air is supplied from the vent hole portion to the medium. Accordingly, in the case of planting the cutting, the seed, and the sapling immediately after the transplantation into the medium, portions of these on the ground, which are exposed on the medium, are maintained in the high-humidity environment, and meanwhile, the inside of the medium, that is, portions of these under the ground are exposed in the low-humidity environment. Therefore, the formation of the plant roots is promoted, and the rooting rate and the extension of the roots in the plant cultivated in the medium are enhanced and promoted, respectively.

According to the plant cultivation container as described in claim 2, the partition wall that partitions the inside of the container body into two upper and lower portions (layers) and supports the medium is provided, the upper portion of the container body partitioned by the partition wall constitutes the high humidity chamber, the lower portion of the container body constitutes the low-humidity chamber, and the vent hole portion that allows the medium and the lower-humidity chamber to communicate with each other is provided in the partition wall. Accordingly, in the case of planting the cutting, the seed, and the sapling immediately after the transplantation into the medium, the portions of these on the ground, which are exposed on the medium, are maintained in the high-humidity environment, and meanwhile, the inside of the medium, that is, the portions of these under the ground receive inflow of the low-humidity air from the low-humidity chamber through the vent hole portion provided in the partition wall, and are exposed to the low-humidity environment. Therefore, the formation of the plant roots is promoted, and the rooting rate and the extension of the roots in the plant cultivated in the medium are enhanced and promoted, respectively.

According to the plant cultivation container as described in claim 3, in the plant cultivation container as described in claim 2, the high-humidity chamber of the container body includes the water reservoir portion for creating the high humidity and supplying the water to the medium, the container body including the water feed portion that feeds the water to the water reservoir portion, the air feed portion that feeds the low-humidity air into the low-humidity chamber, and the exhaust portion that exhausts the air from the high-humidity chamber. Accordingly, the low-humidity air is fed from the air feed portion into the low-humidity chamber, whereby the inside of the low-humidity chamber can be easily set in the low-humidity state, and further, the low-humidity air fed into the low-humidity chamber can be actively fed to the medium through the vent hole portion provided in the partition wall, and the inside of the medium can be effectively set in the low-humidity state. Meanwhile, in the high-humidity chamber, the water reserved in the water reservoir portion is evaporated, whereby the inside of the high-humidity chamber can be set in the high-humidity state.

According to the plant cultivation container as described in claim 4, in the plant cultivation container as described in claim 2 or 3, the above-mentioned medium is housed in the pot, and accordingly, it becomes easy to exchange the medium and to take out the produced sapling. Further, the vent hole portion provided in the partition wall also serves as a fitting hole that fits to the pot, the pot is supported to be fitted to the fitting hole in a fluid tight manner. Still further, the water reservoir portion for creating the high humidity and supplying the water to the medium is provided in the high-humidity chamber of the container body, and the water reservoir portion is provided on the partition wall so as to surround a circumferential wall of the pot, the circumferential wall of the pot being provided with the water supply port that supplies the water in the water reservoir portion to the medium housed in the pot. Yet further, the one of the bottom surface and the circumferential wall of the pot is provided with the air supply port that supplies the air in the low-humidity chamber to the medium housed in the pot, the one of the bottom surface and the circumferential wall protruding from the fitting hole into the low-humidity chamber. Accordingly, in the case of planting the cutting, the seed and the sapling immediately after the transplantation into the above-mentioned medium, the portions of these on the ground, which are exposed on the medium, are maintained in the high-humidity environment, and meanwhile, the inside of the medium, that is, the portions of these under the ground receive the inflow of the low-humidity air from the low-humidity chamber through the air supply port of the pot fitted to the fitting hole that also serves as the vent hole portion provided in the partition wall, and the inside of the medium can be set in the low-humidity state. Further, the water reserved in the water reservoir portion provided on the partition wall can be supplied to the medium housed in the pot from the water supply port provided in the circumferential wall of the pot, and in addition, the water in the water reservoir portion is evaporated, whereby the inside of the high-humidity chamber can be set in the high-humidity state.

According to the plant cultivation container as described in claim 5, in the plant cultivation container as described in claim 2 or 3, the above-mentioned medium is housed in a pot, the pot is supported on the partition wall so that a bottom surface of the pot abuts on a periphery of the vent hole portion provided in the partition wall in a fluid tight manner. Further, the water reservoir portion for creating the high humidity and supplying the water to the medium is provided in the high-humidity chamber of the container body, and the water reservoir portion is provided so as to surround a circumferential wall of the pot, the circumferential wall of the pot being provided with the water supply port that supplies the water reserved in the water reservoir portion to the medium housed in the pot. Still further, the bottom surface of the pot is provided with the air supply port that communicates with the vent hole portion provided in the partition wall and supplies the air in the low-humidity chamber to the medium housed in the pot. Accordingly, in the case of planting the cutting, the seed and the sapling immediately after the transplantation into the above-mentioned medium, the portions of these on the ground, which are exposed on the medium, are maintained in the high-humidity environment, and meanwhile, the inside of the medium, that is, the portions of these under the ground receive the inflow of the low-humidity air from the low-humidity chamber through the vent hole portion provided in the partition wall and the air supply port provided in the bottom surface of the pot, and the inside of the medium can be set in the low-humidity state. Further, the water in the water reservoir portion provided on the partition wall can be supplied to the medium housed in the pot from the water supply port provided in the circumferential wall of the pot, and in addition, the water in the water reservoir portion is evaporated, whereby the inside of the high-humidity chamber can be set in the high-humidity state.

The method of producing a rooted cutting as described in claim 6 is a method of producing a rooted cutting, which is performed by using the plant cultivation container as described in any one of claims 2 to 5. According to the above-mentioned method, a cutting is inserted into the medium provided in the inside of the container body, and is then cultivated and is rooted. Accordingly, the rooting rate from the cutting is enhanced, and the extension of the roots is also promoted, whereby healthy and good-quality cuttings can be obtained with good productivity.

According to the method of producing a rooted cutting as described in claim 7, under the conditions in which nitrogen, phosphorus, and potassium are contained in the water in the water reservoir portion while a carbon source is excluded therefrom, the method is performed while setting humidity in the high-humidity chamber to 90% or more and humidity in the low-humidity chamber to 80% or less and controlling a concentration of carbonic acid gas in the container body. Accordingly, even in a plant in which it has been difficult to root a cutting by the conventional cutting rooting method, a rooting rate therefrom can be enhanced to a large extent.

According to the method of producing a rooted cutting as described in claim 8, the method of producing a rooted cutting as described in claim 7 is performed under a nonsterile condition. Accordingly, the above-mentioned method can be implemented by using simple equipment without requiring complicated operations.

According to the method of producing a rooted cutting as described in claim 9, the method of producing a rooted cutting as described in claim 7 or 8 is performed while controlling the concentration of the carbonic acid gas in the container body to 300 to 1500 ppm. Accordingly, the rooting rate from the cutting and the extension of the rooted roots can be achieved most effectively.

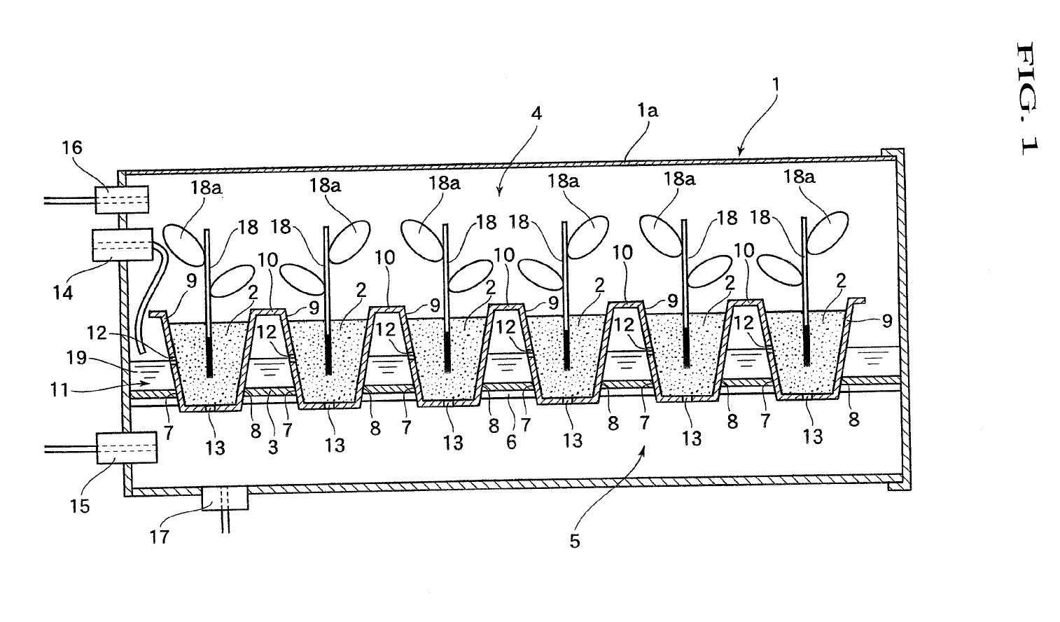

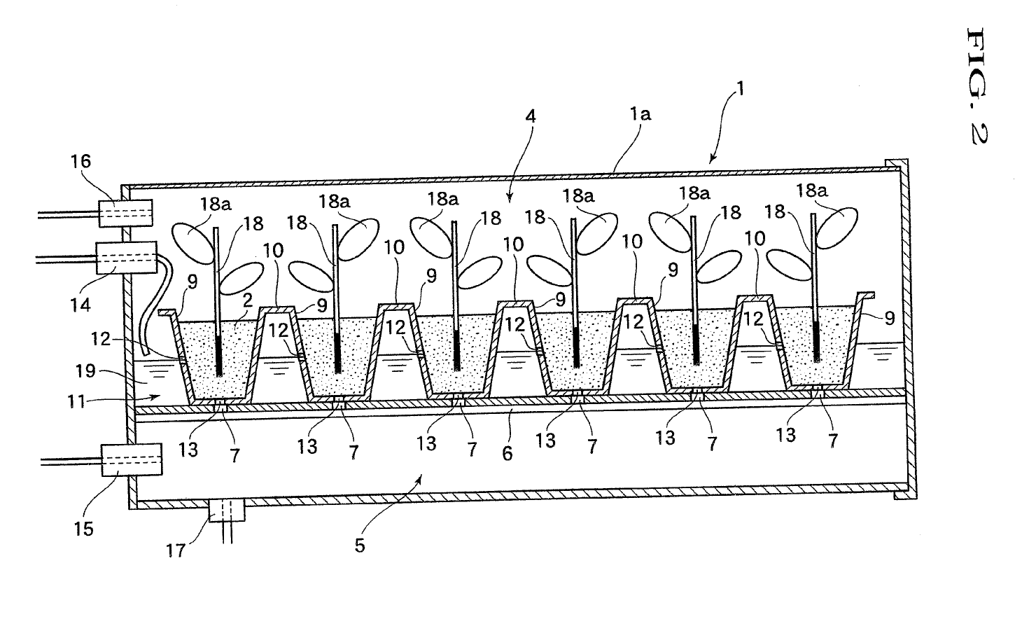

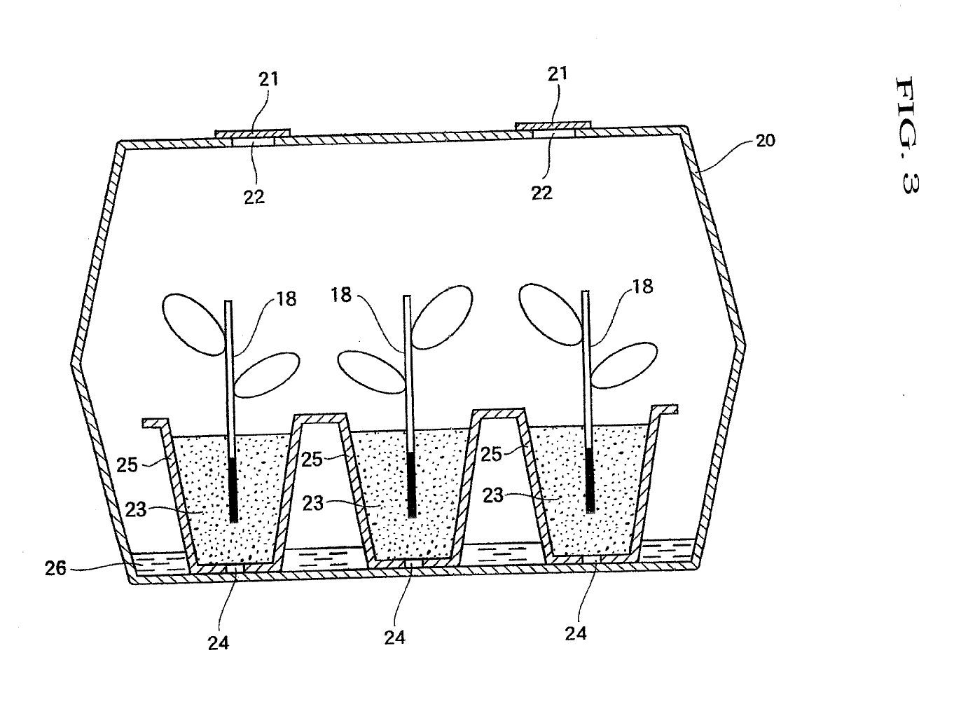

### BRIEF DESCRIPTION OF THE DRAWINGS

[FIG. 1] is a longitudinal cross-sectional view illustrating a first embodiment of a plant activation container according to the present invention.

[FIG. 2] is a longitudinal cross-sectional view illustrating a second embodiment of the plant activation container according to the present invention.

[FIG. 3] is a cross-sectional view illustrating a plant cultivation container according to Comparative Example 1.

### DESCRIPTION OF SYMBOL

1 container body

1a openable top

2 plant cultivating medium

3 partition wall

4 high-humidity chamber

5 low-humidity chamber

6 support member

7 vent hole

8 fitting hole

9 pot

10 coupling portion

11 reservoir portion

12 water supply port

13 air supply port

14 water feed portion

15 air feed portion

16 exhaust portion

17 water drain portion

18 cutting

18a leave

19 19

20 container body

21 air-permeable film

22 opening

23 medium

24 hole

25 pot

26 culture solution

### BEST MODE FOR CARRYING OUT THE INVENTION

Description is made below in detail of a best mode for carrying out the present invention with reference to an example of embodiments illustrated in the drawings.

FIG. 1 is a longitudinal cross-sectional view illustrating a first embodiment of a plant cultivation container according to the present invention. In the plant cultivation container of this example, a plant cultivating medium 2 is provided in an inside of a container body 1 with a substantially hermetically sealed structure. The container body 1 is made of a transparent acrylic resin, and is formed into a quadrangular box shape. An upper portion of the container body 1 is constituted by an openable top 1a.

In the container body 1, there is provided a partition wall 3 that partitions the inside of the container body 1 into two upper and lower layers and supports the medium 2. An upper portion of the container body 1 partitioned by the partition wall 3 constitutes a high-humidity chamber 4, and a lower portion thereof constitutes a low-humidity chamber 5. The partition wall 3 is supported by a support member 6 provided on inner walls of the container body 1 in a fluid tight manner, and partitions the inside of the container body 1 into the upper and lower layers in the fluid tight manner.

In the partition wall 3, vent holes 7 which allow the medium 2 supported by the partition wall 3 and the low-humidity chamber 5 to communicate with each other are provided. In this example, the vent holes 7 also serve as fitting holes 8 which fit pots to be described later thereto. A plurality of the vent holes 7 are provided at a predetermined interval. To the fitting holes 8 provided in the partition wall 3, the pots 9 which individually house the medium 2 therein are fitted in the fluid tight manner so that bottom sides thereof can protrude into the low-humidity chamber 5. Onto inner circumferences of the fitting holes 8, though not shown, seals are attached for maintaining such fluid tightness thereof with circumferential walls of the pots 9. Note that, with regard to the respective pots 9 fitted to the fitting holes 8 in this example, the respective pots 9 adjacent to one another are coupled integrally to one another by coupling portions 10 at upper ends thereof. However, separate bodies from one another may be used as the respective pots 9. Further, when other pots are stacked on the pots concerned, it becomes easy to take out produced saplings.

In the high-humidity chamber 4 of the container body 1, a water reservoir portion 11 for creating high humidity and supplying water to the medium is provided. In this example, the water reservoir portion 11 is surrounded by the inner walls of the container body 1 and the circumferential walls of the pots 9, and is formed on the partition wall 3.

Further, on the high-humidity chamber 4 side of the circumferential walls of the pots 9 fitted to the fitting holes 8 provided in the partition wall 3, there are provided water supply ports 12 which supply water reserved in the water reservoir portion 11 to the medium 2 housed in the pots 9. Furthermore, in bottom surfaces or circumferential walls of the pots 9, which protrude from the fitting holes 8 into the low-humidity chamber 5, there are provided air supply ports 13 which supply air in the low-humidity chamber 5 to the medium 2 housed in the pots 9. These air supply ports 13 also act as water drain ports for the water in the pots 9.

As the medium 2 housed in the pots 9, for example, there are used natural soil such as sand and red gravel, artificial soil such as vermiculite, pearlite and glass beads, a porous molded article such as foam phenol and rock wool, or the like. The porous molded article made of the foam phenol is commercially available, for example, as “Oasis (registered trademark)” from Smithers-Oasis Company. The pots 9 can also be used in such a manner that, in order to facilitate detachment of the pots, other pots are further stacked on the pots 9, and the medium 2 is housed in the other pots.

Further, in the container body 1, there are provided: a water feed portion 14 that feeds water to the water reservoir portion 11; an air feed portion 15 that feeds low-humidity air into the low-humidity chamber 5; an exhaust portion 16 that exhausts the air from the inside of the high-humidity chamber 4; and a water drain portion 17 that drains, to the outside of the container body 1, the water drained from the air supply ports 13 which serve as the water drain ports provided in the pots 9.

Next, description is made of an embodiment of a plant cultivation method using the plant cultivation container constituted as described above. In the plant cultivation method of this example, a method of producing rooted cuttings is illustrated.

First, the top 1a of the container body 1 is opened, and cuttings 18 are inserted into the medium 2 that serves as rooting beds housed in the pots 9 fitted to the fitting holes 8 (vent holes 7) of the partition wall 3. After that, the top 1a is then closed to achieve a substantially hermetically sealed state.

Next, water 19 is fed from the water feed portion 14 to the water reservoir portion 11 provided in the high-humidity chamber 4 of the container body 1. Such feeding of the water 19 to the water reservoir portion 11 is stopped when a water level of the water reservoir portion 11 reaches an appropriate level that is higher than a position of the water supply ports 12 of the pots 9 and is lower than the upper ends of the pots 9. The water 19 reserved in the water reservoir portion 11 is supplied from the water supply ports 12 to the medium 2 housed in the pots 9, an extra amount of the water 19 is drained to the low-humidity chamber 5 from the air supply ports 13 provided in the bottom surfaces or circumferential walls of the pots 9, and the water 19 drained from the low-humidity chamber 5 is drained from the water drain portion 17 to the outside of the container body 1. Note that, in the water 19, according to needs, there can be contained required amounts of nutrients corresponding to a type of an applied plant, such as nitrogen, phosphorous, and potassium. Further, the low-humidity air is fed from the air feed portion 15 into the low-humidity chamber 5 of the container body 1. Carbonic acid gas can be contained in the low-humidity air fed from the air feed portion 15 into the low-humidity chamber 5 of the container body 1. A concentration of the carbonic acid gas differs depending on the type of the plant used as the cuttings. However, in general, it is preferable to control the concentration of the carbonic acid gas in the container within a range from 300 ppm to 1500 ppm. When the concentration of the carbonic acid gas is lower than 300 ppm, no sharp enhancement or improvement can be expected in either a rooting rate of the cuttings or extension of roots, respectively. Even if the concentration of the carbonic acid gas is increased more than 1500 ppm, the rooting rate of the cuttings and the extension of the roots come not to exhibit enhancement or improvement commensurate to the increased concentration of the carbonic acid gas.

In such a way, the humidity in the high-humidity chamber 4 as an upper portion of the container body 1 defined by partitioning of the partition wall 3 is maintained in a range of 90% or more, and humidity in the low-humidity chamber 5 as a lower portion thereof is maintained within a range of 80% to 50%. Specifically, when the container body 1 in a state as described above is placed under conditions in which temperature in the container body 1 is controlled so as to become a temperature (usually in a range of 20° C. to 30° C.) suitable for cultivating the plant concerned, the water 19 reserved in the water reservoir portion 11 provided in the high-humidity chamber 4 is evaporated at the temperature in the container body 1, and the inside of the high-humidity chamber 4 turns to a high-humidity state. As a result, the humidity in the high-humidity chamber 4 can be maintained in the range of 90% or more.

Meanwhile, with regard to the humidity in the low-humidity chamber 5, water that is evaporated is only the water 19 drained to the low-humidity chamber 5 from the air supply ports 13 provided in the pots 9. In addition, the water 19 is drained from the water drain portion 17 to the outside of the container body 1. Accordingly, the low-humidity chamber 5 does not reach such high humidity as in the high-humidity chamber 4, and further, the low-humidity air fed from the air feed portion 15 into the low-humidity chamber 5 is adjusted, whereby the humidity in the low-humidity chamber 5 can be maintained within the range of 80% to 50%. The low-humidity air fed into the low-humidity chamber 5 passes from the air supply ports 13 of the pots 9 through the medium 2 housed in the pots 9 so as to enter the high-humidity chamber 4, and is drained from the exhaust portion 16 to the outside of the container body 1.

When the rooted cuttings are produced in such a manner as described above, such a situation that the cuttings 18 wither owing to a moisture transpiration function from leaves 18a of the cuttings 18 inserted into the medium 2, and the like can be prevented since the humidity in the high-humidity chamber 4 is in the high-humidity state of 90% or more. Meanwhile, the low-humidity air flows from the low-humidity chamber 5 through the air supply ports 13 into the medium 2 housed in the pots 9, and a low-humidity environment is achieved around peripheries of cut regions of the cuttings 18 inserted into the medium 2, whereby ventilation of the peripheries is improved. Such a low-humidity environment promotes rooting of the cut regions of the cuttings 18 and extension of roots rooted therefrom, and the rooting rate of the cuttings 18 and the extension of the roots are enhanced and promoted, respectively, whereby good-quality rooted cuttings can be produced.

Note that, in the above-mentioned production of the rooted cuttings, through the application of the photoautotrophic cultivation method described in Japanese Patent No. 3861542, a further excellent effect can be obtained.

Specifically, nitrogen, phosphorous, and potassium are contained in the water 19 reserved in the water reservoir portion 11 in the high-humidity chamber 4 of the above-mentioned container body 1. In addition, while controlling the concentration of the carbonic acid gas in the above-mentioned container body 1, the cuttings 18 inserted into the medium 2 housed in the pots 9 are cultivated under the conditions in which the humidity in the above-mentioned high-humidity chamber 4 is set to 90% or more and the humidity in the above-mentioned low-humidity chamber 5 is set to 80% or less. Then, the rooting and the extension of the roots can be further promoted.

In this case, with regard to the nutrients contained in the water 19, nitrogen, phosphorous, and potassium are used as essential elements. As such a culture solution in which the nutrients are contained in the water, a commercially available balanced fertilizer for home gardening and a publicly known liquid medium for cultivating a plant tissue can be used at original concentration or by being diluted as appropriate. For example, with regard to the balanced fertilizer for home gardening, a solution in which “Liquid Hyponex 5-10-5 (registered trademark, manufactured by HYPONeX JAPAN Corp., Ltd.)” containing nitrogen, phosphorous, and potassium as main components is diluted 250 to 500 times can be used as a highly versatile culture solution. With regard to the liquid medium for cultivating a plant tissue, a solution in which a Gamborg B5 medium or a Murashige and Skoog medium (1962, hereinafter abbreviated as MS medium) is diluted 16 times can be used as a highly versatile culture solution.

Note that, the known liquid medium for a plant tissue culture including an MS medium contains, in addition to nitrogen, phosphorus, and potassium, hydrogen, carbon, oxygen, sulfur, calcium, and magnesium as a major element, iron, manganese, copper, zinc, molybdenum, boron, chlorine as a minor element in the form of an inorganic salts or vitamins such as thiamine, pyridoxin, and nicotinic acid. Accordingly, as the liquid medium for a plant tissue culture used as the culture solution, a medium containing, in addition to nitrogen, phosphorus, and potassium, these elements in the form of an inorganic salts or vitamins may be used.

Further, a plant growth regulator can also be contained in the above-mentioned culture solution. For example, each of auxins such as IAA (indoleacetic acid), IBA (indolebutyric acid) and NAA (naphthaleneacetic acid), which promote an occurrence of adventitious roots from the plant tissue, is prepared singly, or two or more thereof are combined together, and 0.1 to 10 mg/l thereof is added to the above-mentioned culture solution, whereby the rooting from the cuttings 18, that is, formation of the rooted cuttings can be promoted.

Meanwhile, a carbon source such as sucrose is not contained in the above-mentioned culture solution. The carbon source is an energy source consumed broadly by many living things. However, when the cuttings 18 are cultivated in a state in which the carbon source is contained in the culture solution, various kinds of minor germs attached to the cuttings and various kinds of minor germs in the cultivation environment breed by consuming, as an energy source, the carbon source in the culture solution, and bring about plant death of the cuttings and of saplings which are to be formed. Accordingly, the cultivation must be performed under sterile conditions. However, in the case of applying the photoautotrophic cultivation method, the cuttings 18 can use, as the carbon source, the carbonic acid gas in the container body 1, and it becomes unnecessary to contain the carbon source in the culture solution. Further, by the fact that the carbon source is not rather contained in the culture solution, it becomes possible to perform the cultivation under a nonsterile condition and in such a high-humidity environment in which the humidity is 90% ormorewithout any risk of the breeding of the various kinds of minor germs.

In the photoautotrophic cultivation method described in Japanese Patent No. 3861542, it is essential to control the concentration of the carbonic acid gas in the container body 1. In this photoautotrophic cultivation method, the cuttings are imparted with the nutrients such as nitrogen, phosphorous, and potassium from the culture solution, and perform photosynthesis actively. As a result, the concentration of the carbonic acid gas in the container body 1 is decreased, and accordingly, it is necessary to artificially make up for such a decrease. Also in this case, it is preferable to control the concentration of the carbonic acid gas to 300 to 1500 ppm for the above-mentioned reason.

Further, in the above-mentioned photoautotrophic cultivation method, regarding the humidity in the container body 1, it is also essential that the humidity in the above-mentioned high-humidity chamber 4 be set to 90% or more and that the humidity in the above-mentioned low-humidity chamber 5 be set to 80% or less. However, if the plant cultivation container of the present invention is used as described above, such adjustment of the humidity can be performed relatively easily.

Note that, as described above, in the above-mentioned photoautotrophic cultivation method, the carbon source such as sucrose is not contained in the culture solution, and accordingly, under the nonsterile condition, the cuttings can be cultivated, and the rooted cuttings can be produced. However, in order to produce healthier saplings more reliably, it is preferable to perform treatment such as dry heat sterilization and autoclave sterilization for the inside of the container body 1, the pots 9, the medium 2, the water 19 (culture solution) in which the nutrients are contained, and the like in advance before the insertion of the cuttings.

FIG. 2 is a longitudinal cross-sectional view illustrating a second embodiment of the plant cultivation container according to the present invention. Note that portions corresponding to those of the above-mentioned first embodiment are illustrated while assigning thereto the same reference numerals as those in the first embodiment.

In the cultivation container of this example, pots 9 are supported on a partition wall 3 so that bottom surfaces of the pots 9 can abut on peripheries of vent holes 7 provided in the partition wall 3 in a fluid tight manner. Further, on the bottom surfaces of the pots 9, there are provided air supply pots 13 which communicate with the vent holes 7 provided in the partition wall 3 and supply air in a low-humidity chamber 5 to a medium 2 housed in the pots 9. Other configurations are similar to those of the first embodiment.

Also in the plant cultivation container constituted as described above, as in the case of the first embodiment, the plant cultivation method can be carried out, the method of producing a rooted cutting, in particular, the method of producing a rooted cutting by the photoautotrophic cultivation method described in Japanese Patent No. 3861542 can be carried out advantageously, and similar effects to those in the method using the first embodiment can be obtained.

Note that, in the plant cultivation method and the method of producing a rooted cutting according to the present invention, there are no particular limitations on other conditions, for example, conditions of temperature and light intensity in the event of cultivating the seeds, the saplings, and the cuttings. Appropriate conditions of the temperature, the light intensity, and the like, which correspond to the type of the plant to be cultivated and to the type of the plant for which the rooted cuttings are to be produced, just need to be adopted. Further, in the present invention, a light period while the cultivation is being performed under light irradiation and a dark period while the cultivation is being performed under a dark environment may be set, and the cultivation may be performed while alternately repeating the light period and the dark period. In the case of applying the photoautotrophic cultivation method, the photosynthesis is performed only during the light period, and hence the control for the carbonic acid gas in such a culturing vessel also just needs to be performed only during the light period.

### Examples

Description is made below of the present invention more specifically with reference to examples.

### Example 1

Current branches of Malus pumila var. domestica were used as the cuttings 18.

Meanwhile, as a plant cultivation container, a plant cultivation container (maximum dimension: length 48 cm×width 34 cm×height 20.8 cm) that was made of polycarbonate, had the shape illustrated in FIG. 1, and had the following structure was used. In the structure of the plant cultivation container, the bottom portions of the commercially available pots 9 (dimension of upper portions: length 3 cm×width 3 cm; depth: 4.5 cm) were fitted to the fitting holes 8 on the partition wall 3 in the fluid tight manner so that only the vent holes 7 opened in the bottom surfaces of the pots 9 could communicate with the low-humidity chamber 5 and that the water supply ports 12 opened in the circumferential walls of the pots 9 could be located on the high-humidity chamber 4 side. Here, in the pots 9, the vent holes 7 had a diameter of ø1.2 cm, and the water supply ports 12 had a diameter of ø0.5 cm, and were opened in the circumferential walls of the pots 9 at positions thereof with a height of 2.5 cm from the bottom surfaces of the pots 9. In the above-mentioned pots 9, “Oasis (registered trademark)” (length 2 cm×width 2 cm×depth 3 cm) manufactured by Smithers-Oasis Company was housed as the medium 2. Into the water reservoir portion 11, a culture solution that was obtained by diluting the B5 liquid medium four times and being added with 2 mg/l of IBA as a plant hormone was filled so that a liquid level thereof could become higher than a height level of the water supply ports 12 of the pots 9, whereby the above-mentioned medium 2 was humidified by this culture solution. Then, each piece of the above-mentioned cuttings 18 was inserted into one pot, and totally, nine pieces thereof were inserted into one cultivation container. Note that the leaves of the cuttings 18 were cut into approximate halves, whereby the transpiration function was suppressed, and whereby the leaves of the cuttings adjacent to one another were prevented from overlapping one another in the case where the cuttings were densely planted.

The above-mentioned plant cultivation container was placed in a cultivation room in which the concentration of the carbonic acid gas was adjusted to 1000 ppm, the temperature was adjusted to 25° C., and the humidity was adjusted to 60%. Into the low-humidity chamber 5 partitioned by the partition wall 3 in the container body 1, air (in connection with the above, here, the concentration of the carbonic acid gas was 1000 ppm, the temperature was 25° C., and the humidity was 60%) in the cultivation room was fed from the air supply portion 15 at approximately 2000 cc/min by using a pump. While feeding the air in the cultivation room as described above, the cuttings 18 inserted into the medium 2 in the above-mentioned container body 1 were cultivated under irradiation of light (40 μmol photons s⁻¹·m⁻²) containing a wavelength component of 650 to 670 nm and a wavelength of 450 to 470 nm in a ratio of 8:2, and a rooting status from the cuttings 18 was observed. At this time, the humidity in the high-humidity chamber 4 was 92% in average, and the humidity in the low-humidity chamber 5 was 78% in average.

Three weeks after the insertion, the number of cuttings which rooted, and the number and length of roots generated per cutting were examined. Results are shown in Table 1.

### Comparative Example 1

As a plant cultivation container, a plant cultivation container (maximum dimension: length 11 cm×width 11 cm×height 10 cm) that was made of polycarbonate and had a cubic shape illustrated in FIG. 3, in which a middle body portion swelled a little, was used. On a top surface of a container body 20 of the plant cultivation container, there were provided two circular openings 22 with a diameter of 1 cm, onto which air-permeable films 21 (“Milliseal” manufactured by Millipore Corporation) which were made of polytetrafluoroethylene and had a pore diameter of 0.45 μm were pasted.

In this plant cultivation container, nine commercially available pots 25 (length 3 cm×width 3 cm; depth: 4.5 cm) were placed. In the pots 25, “Oasis (registered trademark)” (length 2 cm×width 2 cm×depth 3 cm) manufactured by Smithers-Oasis Company was housed as a medium 23, and in bottom surfaces of the pots 9, holes 24 with a diameter of 01.2 cm were opened. Then, the above-mentioned medium 23 was humidified by a culture solution 26 that was obtained by diluting the B5 liquid medium four times and being added with 2 mg/l of IBA as a plant hormone. Then, each piece of the cuttings 18 was inserted into one pot, and totally, nine pieces thereof were inserted into one cultivation container. After that, the cuttings 18 were cultivated as in the case of Example 1 except that portions other than the openings 22 onto which the above-mentioned air-permeable films 21 were pasted were substantially hermetically sealed, and that air feeding and exhausting and water feeding and draining were not particularly performed. Then, a rooting status from the cuttings 18 was observed. Humidity in such a rooting container at this time was 97% in average.

Three weeks after the insertion, the number of cuttings which rooted, and the number and length of roots generated per cutting were examined. Results are shown in Table 1.

TABLE 1

| | Number | Number of | | Number | Length |
|---|---|---|---|---|---|
| | of | rooted | Rooting | of | of |
| | samples | individuals | rate | roots | roots |
| | (pieces) | (pieces) | (%) | (pieces) | (mm) |
| Example 1 | 9 | 9 | 100 | 14 ± 2 | 20 ± 1 |
| Comparative | 9 | 7 | 78 | 3 ± 1 | 19 ± 2 |
| Example 1 | | | | | |

As apparent from Table 1, by cultivating the cuttings with use of the plant cultivation container of the present invention, the formation of the adventitious roots of the cuttings was promoted, and both of the rooting rate and the average number of roots were increased in the case of Example 1 as compared with the case of Comparative Example 1. The rooting rate and the average number of roots in Comparative Example 1 were 78% and three pieces, respectively, whereas the rooting rate and the average number of roots in Example 1 were 100% and 14 pieces, respectively.

### Example 2

Current branches of Benifuki, which is one kind of Camellia sinennsis were used as the cuttings 18.

Meanwhile, as a plant cultivation container, a plant cultivation container (maximum dimension: length 48 cm×width 34 cm×height 14.8 cm) that was made of polycarbonate, had the shape illustrated in FIG. 1, and had the following structure was used. In the structure of the plant cultivation container, the bottom portions of the commercially available pots 9 (dimension of upper portions: length 3 cm×width 3 cm; depth: 4.5 cm) were fitted to the fitting holes 8 on the partition wall 3 in the fluid tight manner so that only the vent holes 7 opened in the bottom surfaces of the pots 9 could communicate with the low-humidity chamber 5 and that the water supply ports 12 opened in the circumferential walls of the pots 9 could be located on the high-humidity chamber 4 side. Here, in the pots 9, the vent holes 7 had a diameter of 01.2 cm, and the water supply ports 12 had a diameter of 00.5 cm, and were opened in the circumferential walls of the pots 9 at positions thereof with a height of 2.5 cm from the bottom surfaces of the pots 9. In the above-mentioned pots 9, “Oasis (registered trademark)” (length 1 cm×width 1 cm×depth 2 cm) manufactured by Smithers-Oasis Company was housed as the medium 2. Into the water reservoir portion 11, a culture solution that was obtained by diluting the B5 liquid medium four times and being added with 10 mg/l of IBA as a plant hormone was filled so that a liquid level thereof could become higher than a height level of the water supply ports 12 of the pots 9, whereby the above-mentioned medium 2 was humidified by this culture solution. Then, each piece of the above-mentioned cuttings 18 was inserted into one pot, and totally, twelve pieces thereof were inserted into one cultivation container. Note that the leaves of the cuttings 18 were cut into approximate halves, whereby the transpiration function was suppressed, and whereby the leaves of the cuttings adjacent to one another were prevented from overlapping one another in the case where the cuttings were densely planted.

The above-mentioned plant cultivation container was placed in a cultivation room in which the concentration of the carbonic acid gas was adjusted to 1000 ppm, the temperature was adjusted to 25° C., and the humidity was adjusted to 60%. Into the low-humidity chamber 5 partitioned by the partition wall 3 in the container body 1, air (in connection with the above, here, the concentration of the carbonic acid gas was 1000 ppm, the temperature was 25° C., and the humidity was 60%) in the cultivation room was fed from the air supply portion 15 at approximately 2000 cc/min by using a pump. While feeding the air in the cultivation room as described above, the cuttings 18 inserted into the medium 2 in the above-mentioned container body 1 were cultivated under irradiation of light (40 μmol photons s⁻¹·m⁻²) containing a wavelength component of 650 to 670 nm and a wavelength of 450 to 470 nm in a ratio of 8:2, and a rooting status from the cuttings 18 was observed. At this time, the humidity in the high-humidity chamber 4 was 92% in average, and the humidity in the low-humidity chamber 5 was 78% in average.

Three weeks after the insertion, the number of cuttings which rooted, and the number and length of roots generated per cutting were examined. Results are shown in Table 2.

### Comparative Example 2

A plant cultivation container similar to the plant cultivation container used in Comparative Example 1 was used. Twelve commercially available pots 25 (diameter of upper portion: ø2 cm; depth: 2.5 cm) were housed and placed in this plant cultivation container. In the pots 25, “Oasis (registered trademark)” (length 1 cm×width 1 cm×depth 2 cm) manufactured by Smithers-Oasis Company was housed as the medium 23, and in bottom surfaces of the pots 25, holes 24 with a diameter of ø0.6 cm were opened. Then, the above-mentioned medium 23 was humidified by a culture solution 26 that was obtained by diluting the B5 liquid medium four times and being added with 10 mg/l of IBA as a plant hormone. Then, each piece of the cuttings was inserted into one pot, and totally, twelve pieces thereof were inserted into one cultivation container. Thereafter, the cuttings were cultivated as in the case of Example 2 except that portions other than the openings 22 onto which the air-permeable films 21 were pasted were substantially hermetically sealed, and that the air feeding and exhausting and the water feeding and draining were not particularly performed. Then, a rooting status from the cuttings was observed. Humidity in such a rooting container at this time was 97% in average.

Three weeks after the insertion, the number of cuttings which rooted, and the number and length of roots generated per cutting were examined. Results are shown in Table 2.

TABLE 2

| | Number | Number of | | Number | Length |
|---|---|---|---|---|---|
| | of | rooted | Rooting | of | of |
| | samples | individuals | rate | roots | roots |
| | (pieces) | (pieces) | (%) | (pieces) | (mm) |
| Example 2 | 12 | 11 | 92 | 10 ± 2 | 6 ± 0 |
| Comparative | 12 | 0 | 0 | 0 ± 0 | 0 ± 0 |
| Example 2 | | | | | |

As obvious from Table 2, by cultivating the cuttings with use of the plant cultivation container of the present invention, the formation of the adventitious roots of the cuttings was promoted, and the rooting rate in the case of Example 2 was 92%, whereas the rooting rate in the case of Comparative Example 2 was 0%. In addition, the number of roots per one cutting that rooted in the case of Example 2 was approximately ten.

### Example 3

Current branches of Olea europaea were used as the cuttings 18.

In this example, the above-mentioned cuttings 18 were cultivated as in the case of Example 2 except that soil in which vermiculite, pearlite, and peat moss were mixed together in a ratio of 2:2:4 was used as the medium 2, and that each piece of the cuttings 18 was inserted into one pot, and totally, eight pieces thereof were inserted into one cultivation container. Then, a rooting status from the cuttings 18 was observed. Four weeks after the insertion, the number of cuttings which rooted, and the number and length of roots generated per cutting were examined. Results are shown in Table 3.

### Comparative Example 3

The cuttings 18 were cultivated as in the case of Comparative Example 2 except that current branches of Olea europaea were used as the cuttings, that the soil in which vermiculite, pearlite, and peat moss were mixed together in the ratio of 2:2:4 was used as the medium 23, and that each piece of the above-mentioned cuttings 18 was inserted into the medium 23 housed in the pot 25, and totally, eight pieces thereof were inserted into one cultivation container. Then, a rooting status from the cuttings 18 was observed. Humidity in such a rooting container at this time was 97% in average.

Four weeks after the insertion, the number of cuttings which rooted, and the number and length of roots generated per cutting were examined. Results are shown in Table 3.

TABLE 3

| | Number | Number of | | Number | Length |
|---|---|---|---|---|---|
| | of | rooted | Rooting | of | of |
| | samples | individuals | rate | roots | roots |
| | (pieces) | (pieces) | (%) | (pieces) | (mm) |
| Example 3 | 8 | 6 | 75 | 2.3 ± 0.4 | 2.1 ± 0.5 |
| Comparative | 8 | 0 | 0 | 0 ± 0 | 0 ± 0 |
| Example 3 | | | | | |

As obvious from Table 3, by cultivating the cuttings with use of the plant cultivation container of the present invention, the formation of the adventitious roots of the cuttings was promoted, and the rooting rate in the case of Example 3 was 75%, whereas the rooting rate in the case of Comparative Example 3 was 0%. In addition, a plurality of roots were rooted per one cutting in the case of Example 3.

1. A plant cultivation method that is performed by using a plant cultivation container in which a plant cultivating medium is provided in an inside of a container body with a substantially hermetically sealed structure, the plant cultivation method comprising the steps of:
setting an upper portion of the container body in a high-humidity state and setting a lower portion of the container body in a low-humidity state, the container body being provided with a partition wall for partitioning the inside thereof into these two upper portion and lower portion, and for supporting the plant cultivating medium; and
supplying low-humidity air to the plant cultivating medium from a vent hole provided in the partition wall, the vent hole allowing the plant cultivating medium and the lower portion set in the low-humidity state to communicate with each other.

2. A plant cultivation container in which a plant cultivating medium is provided in an inside of a container body with a substantially hermetically sealed structure, the plant cultivation container comprising:
a partition wall that is provided in the inside of the container body, partitions the inside of the container body into two upper portion and lower portion, and supports the plant cultivating medium, the upper portion of the container body partitioned by the partition wall constituting a high-humidity chamber, the lower portion of the container body constituting a low-humidity chamber; and
a vent hole portion that is provided in the partition wall and allows the plant cultivating medium and the low-humidity chamber to communicate with each other.

3. A plant cultivation container according to claim 2, wherein the high-humidity chamber of the container body comprises a water reservoir portion for creating high humidity and supplying water to the plant cultivating medium, the container body comprising
a water feed portion that feeds water to the water reservoir portion,
an air feed portion that feeds low-humidity air into the low-humidity chamber, and
an exhaust portion that exhausts air from the high-humidity chamber.

4. A plant cultivation container according to claim 2, wherein:
the plant cultivating medium is housed in a pot;
the vent hole portion provided in the partition wall also serves as a fitting hole that fits to the pot;
the pot is supported to be fitted to the fitting hole in a fluid tight manner;
the water reservoir portion for creating the high humidity and supplying the water to the plant cultivating medium is provided in the high-humidity chamber of the container body;
the water reservoir portion is provided on the partition wall so as to surround a circumferential wall of the pot;
the circumferential wall of the pot is provided with a water supply port that supplies the water in the water reservoir portion to the plant cultivating medium housed in the pot; and
one of a bottom surface or a circumferential wall of the pot is provided with an air supply port that supplies the air in the low-humidity chamber to the plant cultivating medium housed in the pot, the one of the bottom surface and the circumferential wall protruding from the fitting hole into the low-humidity chamber.

5. A plant cultivation container according to claim 2, wherein:
the plant cultivating medium is housed in a pot;
the pot is supported on the partition wall so that a bottom surface of the pot abuts on a periphery of the vent hole portion provided in the partition wall in a fluid tight manner;
the water reservoir portion for creating the high humidity and supplying the water to the plant cultivating medium is provided in the high-humidity chamber of the container body;
the water reservoir portion is provided so as to surround a circumferential wall of the pot;
the circumferential wall of the pot is provided with a water supply port that supplies the water in the water reservoir portion to the plant cultivating medium housed in the pot; and
the bottom surface of the pot is provided with an air supply port that communicates with the vent hole portion provided in the partition wall and supplies the air in the low-humidity chamber to the plant cultivating medium housed in the pot.

6. A method of producing a rooted cutting, which is performed by using the plant cultivation container according to claim 2, the method comprising the steps of:
inserting a cutting into the plant cultivating medium provided in the inside of the container body to cultivate the cutting; and
rooting the cutting.

7. A method of producing a rooted cutting according to claim 6, wherein, under conditions in which nitrogen, phosphorus, and potassium are contained in the water in the water reservoir portion while a carbon source is excluded therefrom, the cutting is cultivated while setting humidity in the high-humidity chamber to 90% or more and humidity in the low-humidity chamber to 80% or less and controlling a concentration of carbonic acid gas in the container body so that the cutting is allowed to be rooted.

8. A method of producing a rooted cutting according to claim 7, wherein the cutting is cultivated under a nonsterile condition.

9. A method of producing a rooted cutting according to claim 7, wherein the method is performed while controlling the concentration of the carbonic acid gas in the container body to 300 to 1500 ppm.
